(19) United States
(12) Patent Application Publication
(10) Pub. No.: US 2026/0009909 A1
(43) Pub. Date: Jan. 8, 2026

(54) Method for detecting an interfering signal in a GNSS receiver and associated detection device

(71) Applicant: THALES, Meudon (FR)

(72) Inventors: Nicolas MARTIN, VALENCE CEDEX (FR); Alexandre ARNAUDON, VALENCE CEDEX (FR); Sélim BELBACHIR, VALENCE CEDEX (FR)

(21) Appl. No.: 18/880,000

(22) PCT Filed: Jul. 6, 2023
(86) PCT No.: PCT/EP2023/068756

§ 371 Date: Dec. 30, 2024

(30) Foreign Application Priority Data
Jul. 7, 2022 (FR) 2206942

(51) Int. Cl. G01S 19/21

(52) U.S. Cl. CPC G01S 19/21

(57) ABSTRACT

A method for detecting an interfering signal in a GNSS receiver, including calculating k groups of isolated correlators over an integration interval, each group of isolated correlators being composed of the same number and same types of correlators as a tracking group of correlators, the correlators of each group of isolated correlators being ahead of or behind the corresponding correlators of the tracking group, determining a plurality of consecutive phase shifts between the punctual correlators of the groups of isolated correlators, estimating a mean phase shift between the correlators inside the groups of isolated correlators, and detecting an interfering signal by applying a likelihood criterion.

### CROSS-REFERENCE TO RELATED APPLICATIONS

This application claims benefit under 35 USC § 371 of PCT Application No. PCT/EP2023/068756 entitled METHOD FOR DETECTING AN INTERFERING SIGNAL IN A GNSS RECEIVER AND ASSOCIATED DETECTION DEVICE, filed on Jul. 6, 2023 by inventors Nicolas Martin, Alexandre Arnaudon and Selim Belbachir. PCT Application No. PCT/EP2023/068756 claims priority of French Patent Application No. 22 06942, filed on Jul. 7, 2022.

### FIELD OF THE INVENTION

The present invention relates to a detection method for detecting an interfering signal in a GNSS receiver.

The present invention also relates to a detection device that implements such a method.

The invention pertains to the technical field of GNSS receivers.

### BACKGROUND OF THE INVENTION

The term ‘GNSS receiver’ is understood to refer to a receiver that is capable of receiving signals originating from a global positioning satellite system (GNSS). In a general sense, a GNSS system is composed of a plurality of satellites that enable a mobile receiver to determine: its position in a terrestrial reference frame, its speed, and the time.

In terms of the field of application, the invention pertains to, for example, vehicles that require a high degree of confidence (integrity) in respect of their geolocation information and data and operating in a disturbed environment.

In particular, the invention may be advantageously applied to vehicles operating at fairly low height in relation to the ground, or indeed even at null height, in an environment (e.g. urban) where the sources of interference are more numerous. This is particularly the case for certain drones, rail and automotive applications.

Among the types of interference present in such environments, one of the best known is more commonly referred to as ‘CW’ (continuous wave) interference.

As is well known, unlike ‘broadband’ type interferers, which have the effect of raising the noise level throughout the band and therefore reducing the margin of tracking loops, which can even lead to the loss of service (loss of availability), ‘continuous wave’ type interference can bias the measurement during a tracking phase only on certain axes, thereby leading to a loss of integrity.

When there is a risk of such interference, it is therefore necessary to detect the effect of this interference on each axis in order to ensure the integrity of the solution, and eventually to correct the effect of this interference on the affected axes so as to improve the availability of the service in the disturbed environment.

The state of the art includes various known techniques for dealing with ‘continuous wave’ type interference.

Among these techniques, there are those based on the diversity of antennas associated with a single receiver. However, the said techniques entail greater complexity in the receiver, as it receives a larger flow of signals to process which then requires heavy software processing. This in turn implies a higher recurring cost due to the antennas and radio frequency channels to be added.

There are also techniques based on detecting inconsistencies in the measurements produced by a single-antenna receiver, without requiring additional assistance. However, the said techniques only detect interference and have a relatively long reaction time.

There are also techniques that include pre-correlation processing such as Amplitude Domain Processing (ADP). However, these techniques only work in the presence of a single continuous wave.

### SUMMARY OF THE DESCRIPTION

The aim of the present invention is to remedy these drawbacks in the state of the art and therefore to provide a method and a device for detecting an interference in a GNSS receiver by one or more continuous wave type interferences, by making use of computing means and a single antenna. In the event of such interference being detected, the invention also provides the means for correcting the information/data items delivered by the GNSS receiver in order to ensure continuity of service.

To this end, the invention relates to a detection method for detecting an interfering signal in a GNSS receiver, the type of interfering signal being a continuous wave interfering signal, the method being implemented during a tracking phase of a satellite and comprising the calculating of a group of tracking correlators over at least one predetermined integration interval, the group of tracking correlators comprising such types as a punctual correlator and at least one offset correlator.

The method comprises the following steps:
calculating of k groups of isolated correlators over said integration interval, each group of isolated correlators being composed of the same number and same types of correlators as the group of tracking correlators, the correlators of each group of isolated correlators being ahead of (leading) or behind (lagging) the corresponding correlators of the tracking group of an integer number of chips;
determining of a plurality of consecutive phase shifts between the punctual correlators of the consecutive groups of isolated correlators;
estimating of a mean phase shift between the correlators inside the groups of isolated correlators by making use of the punctual correlators and the offset correlators of these groups;
detecting of an interfering signal by applying a likelihood criterion between the consecutive phase shifts and the estimated mean phase shift.

According to other advantageous aspects of the invention, the detection method comprises one or more of the following characteristic features, taken into consideration in isolation or in accordance with any technically feasible combination:
the interfering signal is detected when the distance according to the likelihood criterion between vectors calculated based on said phase shifts is less than a predetermined threshold value;
the groups of isolated correlators are selected so as to be consecutive to each integer number of chips;
each group of correlators comprises two offset correlators of the following types: one lead correlator (ahead of) and one lag correlator (behind) the corresponding punctual correlator;
each lead correlator and each lag correlator is spaced apart from the corresponding punctual correlator by a same given distance corresponding to a fraction of a chip;
each consecutive phase shift of the punctual correlators of each pair of consecutive groups of isolated correlators is determined using the argument of a complex number \tilde{Z}_{Pi×Pj} determined as follows:

$${\tilde{Z}}_{Pi \times Pj} = \frac{{Z}_{Pi \times Pj}}{{Z}_{Pj \times Pj}}$$

where:

$${Z}_{Pi \times Pj} = {Z}_{Pi} \cdot conj ( {Z}_{Pj} )$$

and
i and j are the indices of the group of corresponding correlators;
Zₚᵢ and Zₚⱼ are the punctual correlators of the groups of corresponding correlators; and
conj(X) is an operation of complex conjugation of a complex number X;
   the phase shift estimation step for estimating a mean phase shift comprises, for each group of isolated correlators, the determining of an elementary phase shift corresponding to the phase shift between the punctual correlator and the or each offset correlator of this group;
   the phase shift estimation step for estimating a mean phase shift in addition comprises a summation of all of the elementary phase shifts;
   the method further comprising a frequency determination step for determining the frequency of the interfering signal on the basis of a fractional part thereof determined by said consecutive phase shifts and on the basis of an integer part thereof determined by said mean phase shift;
   the method further comprising, when an interfering signal is detected, a correction step for correcting the correlators of the group of tracking correlators using the determined frequency of the interfering signal and the correlators of the isolated groups of correlators.

The object of the invention also relates to a detection device for detecting an interfering signal in a GNSS receiver, comprising the technical means configured so as to implement the method as defined above.

### BRIEF DESCRIPTION OF THE DRAWINGS

These characteristic features and advantages of the invention will become apparent upon reading the description that follows, provided solely by way of non-limiting example, and with reference made to the appended drawings, in which:

FIG. 1 is a schematic view of a global satellite positioning system (GNSS system) and a GNSS receiver;

FIG. 2 is a schematic view of a detection device according to the invention, the device providing the means for detecting an interfering signal in the GNSS receiver shown in FIG. 1;

FIG. 3 is a flowchart of a detection method according to the invention, the method being implemented by the detection device shown in FIG. 2; and

FIG. 4 is a schematic view illustrating the implementation of a step in the detection method shown in FIG. 3.

### DETAILED DESCRIPTION OF EMBODIMENTS

FIG.e 1 in fact depicts a type of global positioning system 10 which is a Global Navigation Satellite System (GNSS).

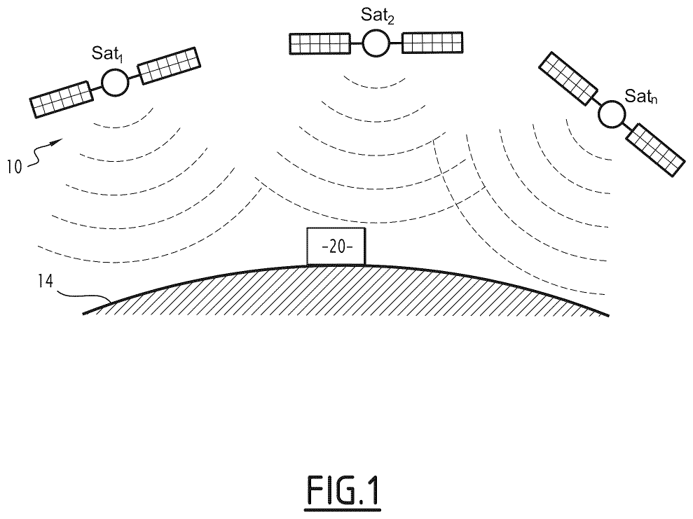

With reference to said FIG. 1, the positioning system 10 comprises a plurality of satellites Satₙ arranged in different orbits around the Earth for which the positioning system 10 is set up.

The total number of satellites Satₙ is, for example, 30.

The index n corresponds to an identifier for each satellite Satₙ and varies, for example, between 1 and 30

Each satellite Satₙ is capable of transmitting electromagnetic signals S to a part of the earth's surface 14 over which it is currently flying.

In particular, the satellites Satₙ are arranged in such a manner that at least four satellites Satₙ are capable of transmitting electromagnetic navigation signals S to substantially every point on the earth's surface 14.

The current position of each satellite Satₙ is characterised by the ephemeris relative to that satellite or by the almanac thereof.

As is known per se, the ephemeris makes it possible to determine the exact position of the satellite Satₙ, whereas the almanac provides only an approximate position.

Each signal S transmitted by each of the satellites Sat, includes a navigation information/data item modulated by a spreading code Cₙ specific to the satellite Satₙ that transmitted the said signal. This modulated navigation information/data item is carried by a carrier wave exp(−jϕₚ) according to a technique known per se.

Each navigation information/data item comprises in particular the time of transmission of the corresponding signal, the ephemeris and the almanac of the satellite Satₙ at the time instant of signal transmission.

Each spreading code Cₙ has a binary code of the pseudo-random type, also known in the state of the art by the abbreviation PRN (for Pseudo Random Noise).

Each spreading code Cₙ is a periodic code with a code period denoted and expressed as an integer number of reference units.

The reference unit is, for example, a chip having a duration which is denoted as T_{chip} and expressed in seconds.

The term ‘chip’ is used to refer to a reference unit corresponding to a slot in a pseudo-random code.

Over the duration of each reference unit, or chip, the spreading code takes on a constant value equal to either +1 or −1.

The signals S transmitted by at least some of the satellites Satₙ are received by a receiver 20.

The receiver 20 is, for example, a portable electronic device and/or an on-board electronic device installed in a vehicle that is moving, for example, over the earth's surface 14 or in proximity thereto at a variable speed.

The receiver 20 is capable of receiving signals S originating from the satellites Satₙ and of extracting from these signals S the navigation information/data items needed to derive its current position, its current speed, and the time, as will be explained hereinafter.

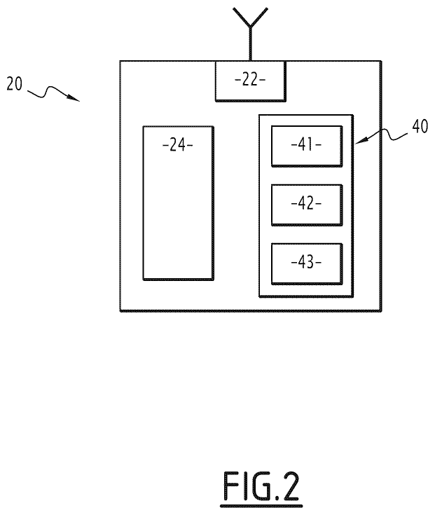

The receiver 20 is illustrated in greater detail in FIG. 2.

Thus, with reference to said FIG. 2, the receiver 20 comprises an antenna 22, a processing module 24 and hardware resources.

The module 24 takes the form, for example, of one or more software programmes which are executed by the hardware resources provided for this purpose, such as a processor, a random access memory, a read-only memory, etc. The hardware resources are powered, for example, by a battery.

In particular, the read-only memory of the receiver 20 is able to store images of the spreading codes Cₙ of each satellite Satₙ.

The antenna 22 is capable of receiving electromagnetic signals Sᵣ corresponding to the signals S transmitted by the satellites Sat when they are within its field of view.

The processing module 24 is capable of executing an acquisition phase for acquiring signals Sᵣ using well-known techniques as well as a tracking phase for tracking signals Sᵣ using well-known techniques.

The operation of the receiver 20 will next be explained.

Upon each start-up of the receiver 20, the processing module 24 initiates a plurality of acquisition channels for all of the satellites Satₙ. Each of these channels is used to acquire navigation information/data item originating from the satellite Satₙ with which it is associated, when this satellite Satₙ is within the field of view of the antenna 22.

The operation of the receiver 20 over each acquisition channel is substantially the same. Therefore, explanation of the operation of the receiver 20 on one channel only will be given below . . . SatₙSatₙ

This channel is associated, for example, with the satellite Satₙ, hereinafter referred to as the desired satellite. It is also assumed that the satellite Satₙ is located within the field of view of the antenna 22.

For each signal received, the receiver 20 and in particular the processing module 24 generates a local signal S_{loc} comprising a local carrier wave exp(−jϕ_{ploc}) and a local spreading code Cₙ(ϕ_{cloc}) corresponding to a local image of the spreading code Cₙ of the desired satellite.

The local signal S_{loc} as a function of time t is then written in the following form:

$${S}_{loc} ( t ) = exp ( - j {ϕ}_{ploc} ( t ) ) \cdot {C}_{n} ( {ϕ}_{cloc} ( t ) ) ,$$

With j²=−1

Then, the processing module 24 initiates the execution of the acquisition phase.

In particular, during the acquisition phase, the processing module 24 determines a Doppler value and a lag value for the received signal Sᵣ relative to the local signal S_{loc}.

The Doppler value corresponds to the frequency shift of the local carrier wave exp(−jϕ_{ploc}) relative to the carrier wave exp(−jϕₚ)Sᵣ of the received signal.

In the example described, the lag value corresponds to the lag of the spreading code Cₙ(ϕc) of this received signal relative to the local spreading code Cₙ(ϕ_{cloc}).

The lag values are determined using known techniques that in particular include the calculating of a group of correlators comprising three types of correlators.

A first type of correlator, referred to as punctual correlator Zₚ, consists of calculating correlations between the received signal Sᵣ and the local signal S_{loc} over a predetermined integration interval T_{P}. In other words expressed as follows:

$${Z}_{P} ( m ) = \frac{1}{{T}_{P}} {\int }_{[ {mT}_{P} , ( m + 1 ) {T}_{P} ]} {S}_{loc}^{*} ( t ) \cdot {S}_{r} ( t ) , \qquad ( rel 1 )$$

where X* denotes conjugate of the complex number X.

A second type of correlator, referred to as lead correlator Z_{A}, consists of calculating correlations between the received signal Sᵣ and a signal corresponding to the local signal S_{loc} in which the local spreading code Cₙ(ϕ_{cloc}+d) is shifted ahead by a value d between 0 and T_{chip}.

A third type of correlator, referred to as lag correlator Z_{R}, consists of calculating correlations between the received signal Sᵣ and a signal corresponding to the local signal S_{loc} in which the local spreading code Cₙ(ϕ_{cloc}−d) is shifted behind by the same value d.

At the end of the acquisition phase, the receiver 20 and in particular the processing module 24, synchronizes the local signal S_{loc} with the signal S transmitted by the desired satellite Satₙ using the determined Doppler and lag values.

Thereafter, the processing module 24 initiates a convergence phase that effectuates a servo closed-loop feedback control of the lag value of the local spreading code Cₙ(ϕ_{cloc}) and of the Doppler value of the local carrier wave exp (−jϕ_{ploc}), on the signal S received from the satellite Satₙ, by means of code tracking loops and carrier tracking loops, in particular by making use of the three types of correlators mentioned above.

This transitional phase serves to make the local spreading code Cₙ(ϕ_{cloc}) and the local carrier wave exp (−jϕ_{ploc}) coincide precisely with the spreading code Cₙ(ϕ_{c}) and the carrier wave exp (−jϕₚ) of the satellite signal S received from the satellite Satₙ.

Thereafter, the processing module 24 initiates the tracking phase.

In particular, during the tracking phase, the processing module 24 regularly updates the Doppler and lag values, which thus enables it to demodulate the received signal Sᵣ and extract therefrom the corresponding navigation information/data item. In order to do this, the processing module 24 in particular uses the three types of correlators mentioned above. The correlators calculated during this tracking phase form a group of tracking correlators. These correlators will hereinafter be denoted by the index 0, i.e. Z_{A0}, Z_{P0}, and Z_{R0}, respectively for the lead, punctual and lag correlators.

Finally, the processing module 24 consolidates all the information/data items acquired by all the acquisition channels and infers therefrom the position of the receiver 20, its speed, and the time.

It sometimes happens that during the tracking phase on one or more channels, the receiver 20 ‘locks on’ to an interfering signal which does not have the same effect as the spreading code of the satellite being tracked. Such a signal may be a continuous wave type interfering signal. With a view to detecting it and possibly correcting the corresponding navigation information/data items, the invention provides a detection device (40) that is associated with the receiver (20).

In the example shown in FIG. 2, the detection device 40 is at least partially integrated into the receiver 20.

In a further exemplary embodiment, the detection device 40 has a unit that is separate from the receiver 20 and is connected to the receiver 20.

The detection device 40 comprises an input module 41 capable of acquiring at least some of the data acquired by the receiver 20, such as the signal Sᵣ received at each time instant during the tracking phase; a processing module 42 that provides the means for processing these data in order to detect an interfering signal and eventually correct at least some of the data items used by the receiver 20; and an output module 43 configured so as to transmit the output resulting from each processing operation executed by the processing module 42, for example to the processing module 24 of the receiver 20.

Each of the modules 41 to 43 is, for example, at least partially in the form of a software programme and/or a programmable logic circuit such as a Field Programmable Gate Array (FPGA). In the event of at least partial deployment of one of these modules by means of a software programme, the detection device 40 also comprises the hardware means for implementing the operation of this software programme, such as a processor and a memory unit.

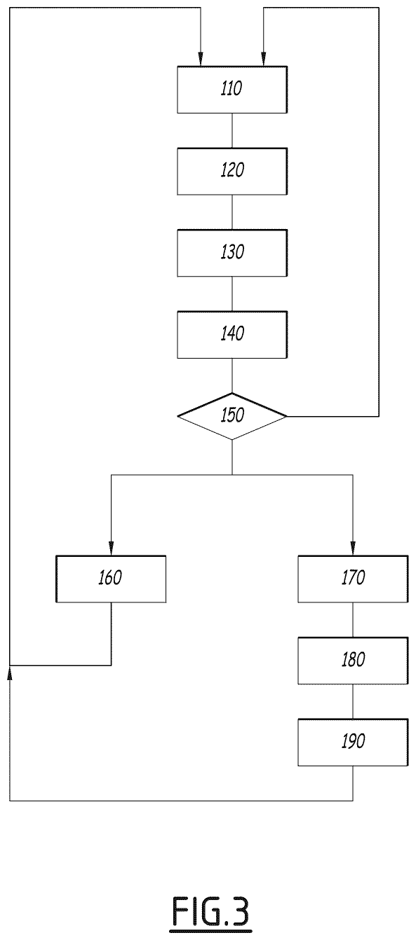

In order to detect a continuous wave type interfering signal and eventually correct the data processed by the receiver 20, the detection device 40 implements a detection method which will be explained hereinafter with reference to FIG. 3 which presents a flow chart of these steps.

During an initial step 110 of this method, the input module 41 acquires all of the data necessary for calculating the correlators, as will be explained in the following steps. In particular, during this step 110, the input module 41 acquires the signal received Sᵣ at the given time instant as well as the local spreading code Cₙ(ϕ_{cloc}) and the local carrier wave exp (−jϕ_{ploc}) corresponding to the satellite being tracked.

During the subsequent step 120, the processing module 42 calculates k groups of isolated correlators over the integration interval T_{P}.

Each group of isolated correlators is composed of the same number and same types of correlators as the group of tracking correlators. These correlators of each group of isolated correlators lead (are ahead of) the corresponding correlators of the tracking group of an integer number of chips.

Advantageously, the groups of isolated correlators are positioned so as to be consecutive to each integer number of chips.

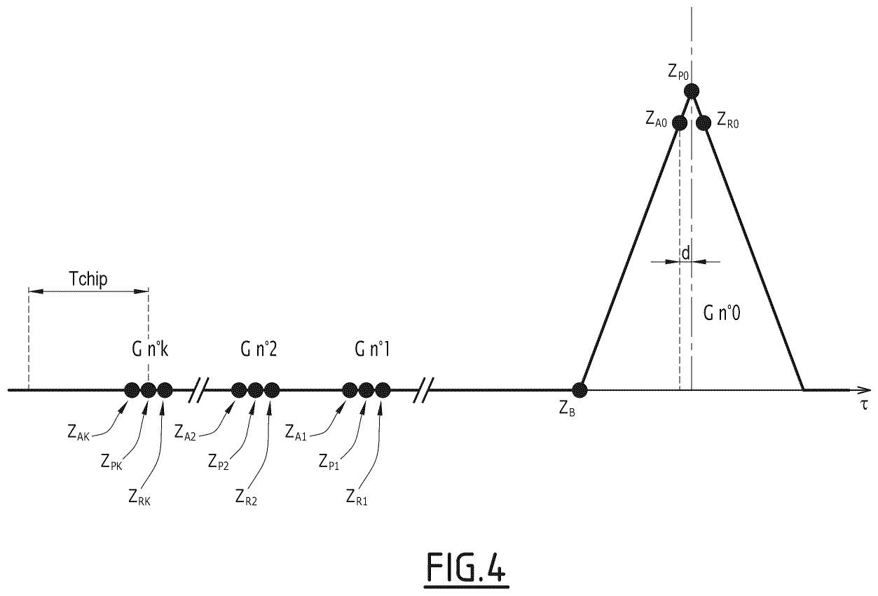

FIG. 4 illustrates an example of the placement of such isolated groups relative to the autocorrelation function of the corresponding spreading code as a function of the lag value τ.

Thus, as can be seen in said FIG. 4, the correlators Z_{A0}, Z_{P0}, and Z_{R0} of the group of tracking correlators Gn0 form a peak of the autocorrelation function. A noise correlator Z_{B}, for estimating the power of the noise, is also placed 1 chip ahead of the punctual correlator Z_{P0}, so as to be at the beginning of the peak.

In this figure the groups of isolated correlators are denoted by the references Gn1 to Gnk, with each group including the following types of correlators: a punctual correlator, hereinafter denoted by Zₚᵢ; a lead correlator, hereinafter denoted by Z_{Ai}, and a lag correlator, hereinafter denoted by Z_{Ri}. These correlators thus do not form a peak that is comparable to that of the group of tracking correlators Gn0.

In order to calculate each of these correlators, the processing module 42 then uses relationship 1 in which the function S_{loc}(t) is calculated using a spreading code which is shifted by an integer number of chips for punctual type correlators and by an integer number of chips plus or minus the distance d for the lead and lag type correlators. This integer number of chips is determined by the position of the corresponding group of isolated correlators relative to the tracking group.

During the subsequent step 130, the processing module 42 determines a plurality of consecutive phase shifts between the punctual correlators of the consecutive groups of isolated correlators.

In particular, each consecutive phase shift of the punctual correlators of each pair of consecutive groups of isolated correlators is determined using the argument of a complex number \tilde{Z}_{Pi×Pj} determined as follows:

$${\tilde{Z}}_{Pi \times Pj} = \frac{{Z}_{Pi \times Pj}}{{Z}_{Pj \times Pj}}$$

where:

$${Z}_{Pi \times Pj} = {Z}_{Pi} \cdot conj ( {Z}_{Pj} )$$

and
i and j are the indices of the corresponding group of correlators varying between 1 and k;
Z_{Pi} and Zₚⱼ are the punctual correlators of the corresponding groups of correlators; and
conj (X) is an operation of conjugation of a complex number X.

In one embodiment, the values Z_{Pi×Pj} are filtered so as to fine tune the detection performance results.

During the subsequent step 140, the processing module 42 estimates a mean phase shift between the correlators inside the groups of isolated correlators. This mean phase shift is estimated by making use of the punctual type correlators and the lead and lag type correlators of these groups.

In order to do this, the processing module 42 first calculates the following values for each group of isolated correlators:

$${Z}_{Ai \times P i} = {Z}_{Ai} \cdot conj ( {Z}_{Pi} )$$

$${Z}_{Pi \times R i} = {Z}_{Pi} \cdot conj ( {Z}_{Ri} )$$

$${Z}_{Ri \times T i} = {Z}_{Ri} \cdot conj ( {Z}_{Ri} )$$

where i is the index of the corresponding group of isolated correlators varying between 1 and k.

Then, using a complex division, the processing module 42 determines the following values:

$${\tilde{Z}}_{Ai \times Pi} = \frac{{Z}_{Ai \times Pi}}{{Z}_{Pi \times Pi}}$$

$${\tilde{Z}}_{Pi \times Ri} = \frac{{Z}_{Pi \times Ri}}{{Z}_{Ri \times Ri}} .$$

The argument of each of these complex numbers corresponds to an elementary phase shift, i.e. the phase shift between the punctual correlator and the lead or lag correlator of the same group of isolated correlators.

The mean phase shift φₑₙₜ is then expressed in the following manner:

$${φ}_{ent} = \frac{1}{d} \cdot {arg}_{[ - π ; π ]} ( {\sum }_{i = 1}^{k} {\tilde{Z}}_{Ai \times P 1} + {\tilde{Z}}_{Pi \times Ri} ) .$$

This value φₑₙₜ corresponds to the integer part of the frequency of the interfering signal, as will be apparent in the following section/s.

During the subsequent step 150, the processing module 42 applies a likelihood criterion between the consecutive phase shifts and the estimated mean phase shift in order to detect a continuous wave interfering signal. In particular, the application of this criterion is based on the fact that in the presence of such type of an interference, the phase shift is the same between two correlators spaced apart by the same distance.

Using U to denote a vector obtained based on the consecutive phase shifts and V to denote a vector obtained based on the mean phase shift φₑₙₜ, these vectors U and V may be written in the following form:

$$U = [ \begin{matrix}{\tilde{Z}}_{P 1 \times P 2} & {\tilde{Z}}_{P 2 \times P 3} & … & {\tilde{Z}}_{Pk - 1 \times P k}\end{matrix} ] ,$$

$$V = exp ( j \cdot {φ}_{ent} ) \cdot [ \begin{matrix}1 & 1 & … & 1\end{matrix} ] .$$

The likelihood criterion may for example include the measurement of a distance dist between these vectors. In particular:

$$dist = {‖ U - V ‖}^{2} .$$

When this distance is lower than a predetermined threshold value (approximately equal to 0.1 for example), the two vectors are considered to be sufficiently close and an interfering signal, ie a continuous wave interfering signal is then detected. If this is not the case, the receiver 20 is considered to be locked on to the correct spreading code.

According to one embodiment, when an interfering signal is detected, the output module 43 during a step 160, transmits this information/data item to the processing module 24 which then rejects the received signal Sᵣ and proceeds anew to acquire this signal. In such an event, the detection process is repeated again using the newly acquired measurements.

According to one other embodiment, when an interfering signal is detected, the processing module 42 proceeds to correct the corresponding measurements so as to ensure the continuity of the service provided by the receiver 20. In order to do this, the processing module 42 executes steps 170 and 180 described below.

During step 170, the processing module 42 determines the frequency f_{CW} of the interfering signal detected based on a fractional part of the latter as determined by said consecutive phase shifts and based on an integer part of the latter as determined by said mean phase shift.

In particular, this frequency is determined as follows:

$${f}_{CW} = \frac{1}{2 π {T}_{chip}} [ 2 π \cdot fix ( \frac{{F}_{e} \cdot {T}_{chip} \cdot {φ}_{ent}}{2 π} ) + {φ}_{frac} ]$$

where:
Fₑ is the sampling frequency;
the function fix(x) is equal to the function sign(x)*floor(abs(x)), which is the integer part for a positive number x; and
φ_{frac} is the fractional part of the interfering signal as determined according to the following expression:

$${φ}_{frac} = {arg}_{[ - π ; π ]} ( {\sum }_{i = 1}^{k - 1} {\tilde{Z}}_{Pi \times Pi + 1} ) .$$

During the subsequent step 180, the processing module 42 corrects the correlators of the tracking group of correlators using the determined frequency of the interfering signal and the correlators of the groups of isolated correlators. Preferably, the processing module 42 also corrects the noise correlator.

In order to do this, the processing module 42 first determines the corrections Z_{CW P} and Z_{CW B} to be applied respectively to the punctual correlator of the tracking group and to the noise correlator. These corrections are calculated as follows:

$${Z}_{CW P} = \frac{1}{k} {\sum }_{i = 1}^{k} {Z}_{Pi} exp ( - 2 {d}_{Pi} j π {f}_{CW} \cdot {T}_{chip} )$$

$${Z}_{CW B} = \frac{1}{k} {\sum }_{i = 1}^{k} {Z}_{Pi} exp ( - 2 {d}_{Bi} j π {f}_{CW} \cdot {T}_{chip} )$$

where
d_{Pi} is the spacing between the punctual correlator of the group i of isolated correlators and the punctual correlator of the tracking group in number of chips; and
d_{Bi} is the spacing between the punctual correlator of the group i of isolated correlators and the punctual correlator of the noise in number of chips.

Thereafter, the processing module 42 derives therefrom the corrections to be applied to the correlators Z_{CW A} and Z_{CW R} which are respectively the lead and lag correlators of the tracking group, as follows:

$${Z}_{CW A} = {Z}_{CW P} exp ( + 2 j π {f}_{CW} \cdot d )$$

$${Z}_{CW R} = {Z}_{CW P} exp ( - 2 j π {f}_{CW} \cdot d ) .$$

The corrected correlators of the tracking group then become:

$${Z}_{A 0 cor} = {Z}_{A 0} - {Z}_{CW A}$$

$${Z}_{P 0 cor} = {Z}_{P 0} - {Z}_{CW P}$$

$${Z}_{R 0 cor} = {Z}_{R 0} - {Z}_{CW R}$$

$${Z}_{B cor} = {Z}_{B} - {Z}_{CW B} .$$

Thereafter, during the subsequent step 190, the output module 43 transmits these corrected correlators Z_{A0 cor}, Z_{P0 cor}, Z_{R0 cor}, and Z_{B cor} whereupon these corrected correlators are then used to compute a navigation information/data item.

Then, the method is carried out again upon the receiver 20 receiving a new signal Sᵣ.

Finally, it should be noted that the detection method is advantageously performed in each of the pre-detection bands 1/T_{P} used in the processing of the received signal Sᵣ.

It can therefore be appreciated that the invention presents a certain number of advantages.

Firstly, it is clear that the invention provides the means for detecting a continuous wave type interfering signal in each band of the received signal. This represents a particular advantage since this type of interference may be only present on one single band.

The invention additionally provides the means for correcting the data acquired by the GNSS receiver in order to ensure the continuity of its service.

Finally, the invention may be operationally implemented using only a single antenna of the receiver and limited computing means. This thus makes it possible to implement the invention in an inexpensive and cost-effective manner.

1. A detection method for detecting a continuous wave interfering signal in a GNSS receiver, the method being implemented during a tracking phase of a satellite and comprising:
calculating a group of tracking correlators over a predetermined integration interval, the group of tracking correlators comprising a punctual correlator and at least one offset correlator;
calculating k groups of isolated correlators over the integration interval, each group of isolated correlators being composed of the same number and same types of correlators as the group of tracking correlators, the correlators of each group of isolated correlators being leading or lagging the corresponding correlators of the tracking group of an integer number of chips;
determining a plurality of consecutive phase shifts between the punctual correlators of the consecutive groups of isolated correlators;
estimating a mean phase shift between the correlators inside the groups of isolated correlators by making use of the punctual correlators and the offset correlators of these groups; and
detecting an interfering signal by applying a likelihood criterion between the consecutive phase shifts and the estimated mean phase shift.

2. A method according to claim 1, wherein the interfering signal is detected when the distance according to the likelihood criterion between vectors calculated based on the phase shifts is less than a predetermined threshold value.

3. A method according to claim 1, wherein the groups of isolated correlators are selected so as to be consecutive to each integer number of chips.

4. A method according to claim 1, wherein each group of correlators comprises one lead correlator and one lag correlator for the corresponding punctual correlator.

5. A method according to claim 4, wherein each lead correlator and each lag correlator is spaced apart from the corresponding punctual correlator by a same given distance corresponding to a fraction of a chip.

6. A method according to claim 1, wherein each consecutive phase shift of the punctual correlators of each pair of consecutive groups of isolated correlators is determined using the argument of a complex number \tilde{Z}_{Pi×Pj} determined as follows:
$${\tilde{Z}}_{Pi \times Pj} = \frac{{Z}_{Pi \times Pj}}{{Z}_{Pj \times Pj}}$$
where:
$${Z}_{Pi \times Pj} = {Z}_{Pi} \cdot conj ( {Z}_{Pj} )$$
and
i and j are the indices of the group of corresponding correlators,
Zₚᵢ and Zₚⱼ are the punctual correlators of the groups of corresponding; correlators, and
conj(X) is an operation of complex conjugation of a complex number X.

7. A method according to claim 1, wherein said estimating comprises, for each group of isolated correlators, determining an elementary phase shift corresponding to the phase shift between the punctual correlator and the or each offset correlator of this group.

8. A method according to claim 7, wherein said estimating further comprises summing all of the elementary phase shifts.

9. A method according to claim 1, further comprising determining a frequency of the interfering signal on the basis of a fractional part thereof determined by the consecutive phase shifts and on the basis of an integer part thereof determined by the mean phase shift.

10. A method according to claim 9, further comprising, when an interfering signal is detected, correcting the correlators of the group of tracking correlators using the determined frequency of the interfering signal and the correlators of the isolated groups of correlators.

11. A detection device for detecting an interfering signal in a GNSS receiver, configured to implement the method according to claim 1.
